(19) United States
(12) Patent Application Publication
(10) Pub. No.: US 2014/0003865 A1
(43) Pub. Date: Jan. 2, 2014

(54) LOCKING APPARATUS

(71) Applicant: FENG LI, Shenzhen City (CN)

(72) Inventor: FENG LI, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/551,634

(22) Filed: Jul. 18, 2012

(30) Foreign Application Priority Data
Jun. 29, 2012 (CN) 2012102211436

(51) Int. Cl. F16D 1/00

(52) U.S. Cl. 403/360

(57) ABSTRACT

A locking apparatus includes a sleeve member, an elastic locking member, and pressing member. The sleeve member includes a first cylinder axially defining a stepped hole, a stepped portion formed in the stepped hole, and a first flange protruding out from an end of the first cylinder. The pressing member includes an inserting pole inserted into the stepped hole and a second flange. The inserting pole defines a positioning slot. The locking member is engaged with the positioning slot and is abutted against the stepped portion.

### BACKGROUND

1. Technical Field

The present disclosure relates to a locking apparatus for connecting two objects.

2. Description of Related Art

To connect two objects, a number of screws or rivets are often applied. However, such means needs additional tools, such as screwdrivers or rivet machines, which is time consuming and troublesome.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a locking apparatus, wherein the locking apparatus includes a sleeve member.

FIG. 2 is an enlarged, partially cutaway view of the sleeve member of FIG. 1.

FIG. 3 is an assembled, partially cutaway isometric view of FIG. 1, showing the locking apparatus in use.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

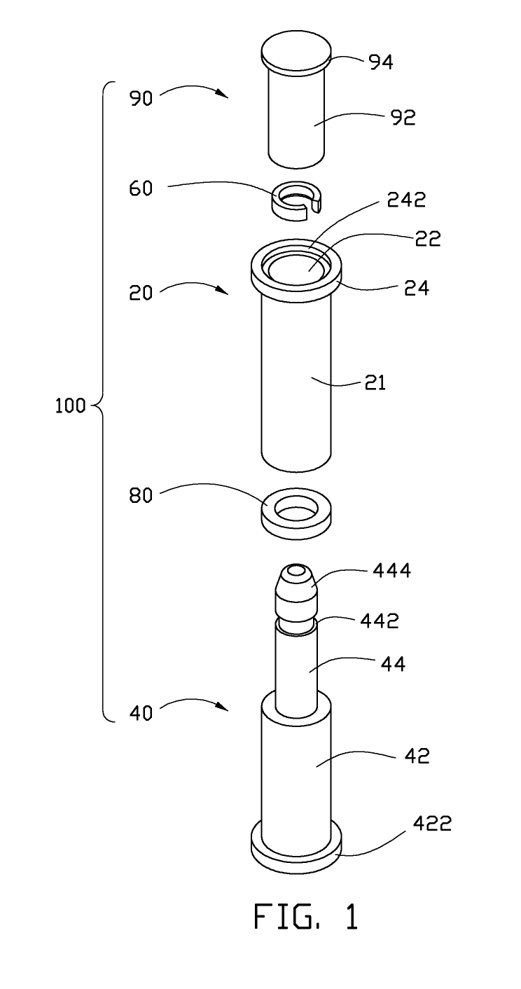

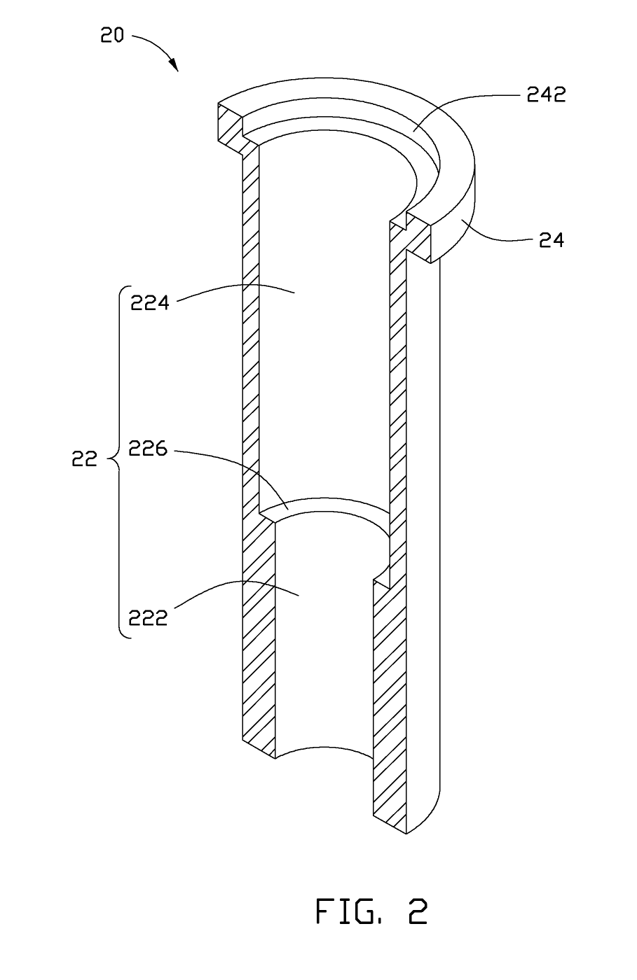

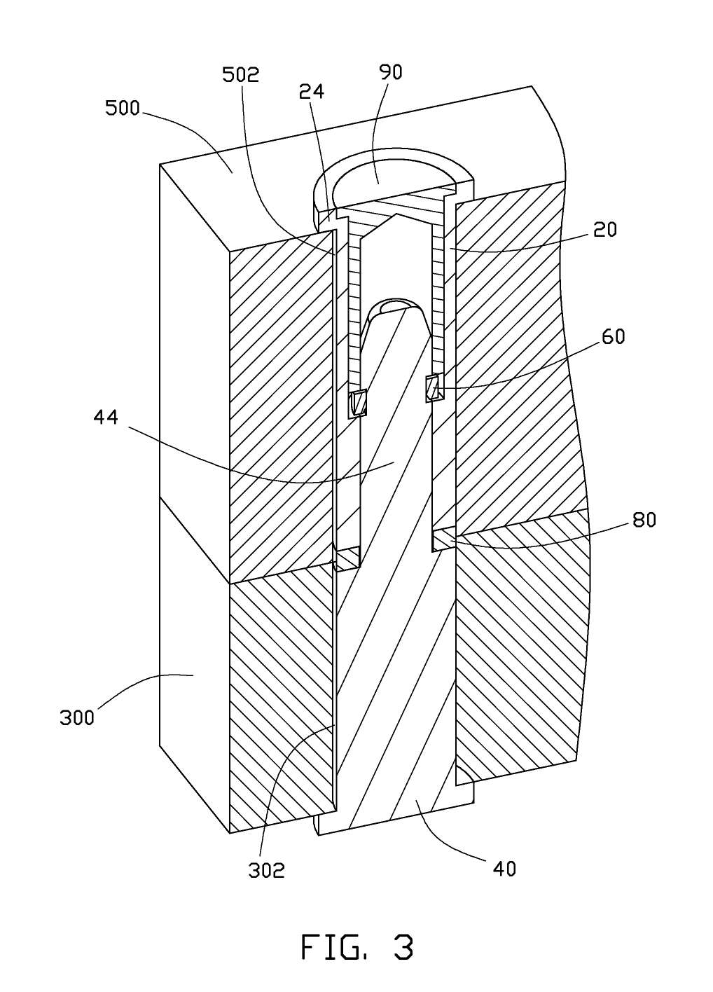

Referring to FIG. 1 and FIG. 2, an embodiment of a locking apparatus 100 is used for connecting a first object 300 defining a through hole 302 and a second object 500 defining a through hole 502 (shown in FIG. 3). The locking apparatus 100 includes a sleeve member 20, a pressing member 40, an elastic locking member 60, a resilient washer 80, and an operation member 90.

The sleeve member 20 includes a first cylinder 21 and a first flange 24 perpendicularly extending out from a first end of the first cylinder 21. The first cylinder 21 axially defines a stepped hole 22. The stepped hole 22 includes a first hole 222 extending through a second end of the first cylinder 21 opposite to the first flange 24, and a second hole 224 adjacent to the first flange 24 and communicating with the first hole 222. The first hole 222 has a smaller diameter than a diameter the second hole 224. A stepped portion 226 is formed at a junction of the first hole 222 and the second hole 224. A receiving portion 242 is bounded by the first flange 24, communicating with and coaxial with the second diameter hole 224.

The pressing member 40 includes a cylindrical connecting pole 42 and an inserting pole 44 axially extending out from a first end of the connecting pole 42. A second flange 422 perpendicularly extends out from a second end of the connecting pole 42, opposite to the inserting pole 44. The inserting pole 44 forms a tapered guide portion 444 on a distal end opposite to the second flange 422, and defines an annular positioning slot 442 adjacent to the guide portion 444. A diameter of the inserting pole 44 is slightly smaller than a diameter of the first hole 222 of the sleeve member 20. A diameter of the connecting pole 42 is larger than the diameter of the first hole 222.

The locking member 60 is substantially C-shaped. An outer diameter of the locking member 60 is larger than the diameter of the first hole 222 of the sleeve member 20, and is less than a diameter of the second hole 224 of the sleeve member 20. In the embodiment, the locking member 60 is made of resilient material, such as steel piece or plastic.

The washer 80 is made of resilient material, such as plastic.

The operation member 90 includes a hollow second cylinder 92 and a resilient third flange 94 projecting out from an end of the second cylinder 92. The second cylinder 92 can be firmly inserted into the second hole 224 of the sleeve member 20.

Referring to FIG. 3, in use, the first object 300 is abutted against the second object 500, to allow the through hole 302 of the first object 300 to align with the through hole 502 of the second object 500. The washer 80 is fitted about the inserting pole 44, and is abutting against an end surface at the first end of the connecting pole 42. The locking member 60 is received in the second hole 224 of the sleeve member 20, and is supported on the stepped portion 226. The second cylinder 92 of the operation member 90 is inserted into the second hole 224. The third flange 94 is received in the receiving portion 242. The locking member 60 is sandwiched between an end of the second cylinder 92 opposite to the third flange 94 and the stepped portion 226. The inserting pole 44 of the pressing member 40 is inserted into the through hole 302 of the first object 300. The first cylinder 21 of the sleeve member 20 is inserted into the through hole 502 of the second connecting member 500. The sleeve member 20 and the pressing member 40 are pressed toward each other. The inserting pole 44 is inserted into the first hole 222. The guide portion 444 slidably abuts against an inner sidewall of the locking member 60, to deform the locking member 60 outward, until the locking member 60 aligns with the positioning slot 442. The locking member 60 is restored to engage with the positioning slot 442. The first object 300 and the second object 500 is sandwiched between the first flange 24 of the sleeve member 20 and the second flange 422 of the pressing member 40.

The washer 80 is resiliently sandwiched between the first cylinder 21 of the sleeve member 20 and the connecting pole 42 of the pressing member 40, thus the first and second objects 300 and 500 can be firmly connected.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A locking apparatus, comprising:
a sleeve member comprising a first cylinder axially defining a stepped hole, and a first flange extending out from a first end of the first cylinder;
an elastic locking member received in the stepped hole and located on a stepped portion of the stepped hole; and
a pressing member comprising a connecting pole, an inserting pole extending from a first end of the connecting pole and inserted into the stepped hole from a second end of the first cylinder opposite to the first flange, and a second flange extending out from a second end of the connecting pole opposite to the inserting pole, wherein the inserting pole defines a positioning slot, the locking member is engaged with the positioning slot.

2. The locking apparatus of claim 1, wherein the stepped hole comprises a first hole adjacent to the first flange and a second hole communicating with the first hole and extending through the second end of the first cylinder, the first hole has a larger diameter than the second hole, the stepped portion is formed at a junction of the first hole and the second hole, the locking member is supported on the stepped portion, the inserting pole is inserted into the second hole.

3. The locking apparatus of claim 2, further comprising an operation member, wherein the operation member comprises a hollow second cylinder inserted into the first hole, the locking member is sandwiched between the second cylinder and the stepped portion.

4. The locking apparatus of claim 3, wherein a receiving portion is bounded by the first flange, and communicates with the first hole, the operation member further comprises a third flange projecting out from the second cylinder and received in the receiving portion.

5. The locking apparatus of claim 1, wherein the locking member is substantially C-shaped.

6. The locking apparatus of claim 1, wherein the inserting pole is cylindrical, the positioning slot is annular and is defined in a distal end of the inserting pole opposite to the second flange.

7. The locking apparatus of claim 6, wherein the distal end of the inserting pole forms a tapered guide portion and located at an outer side of the positioning slot opposite to the second flange.

8. The locking apparatus of claim 1, further comprising a resilient washer fitted about the inserting pole and sandwiched between the first cylinder and the connecting pole.

9. The locking apparatus of claim 8, wherein the washer is made of resilient material.

10. The locking apparatus of claim 1, wherein the locking member is made of resilient material.
